(19) United States
(12) Patent Application Publication
(10) Pub. No.: US 2024/0072581 A1
(43) Pub. Date: Feb. 29, 2024

(54) DOUGHNUT TYPE ELECTROMAGNETIC MOTOR HAVING C-SHAPED STATOR WINDINGS

(71) Applicant: Yunfeng LI, Nanjing, Jiangsu (CN)

(72) Inventor: Yunfeng LI, Nanjing, Jiangsu (CN)

(21) Appl. No.: 18/261,254

(22) PCT Filed: Jan. 25, 2022
(86) PCT No.: PCT/CN2022/073648

§ 371 Date: Jul. 12, 2023

(30) Foreign Application Priority Data
Oct. 27, 2021 (CN) 202122594958.6

(51) Int. Cl. H02K 1/14; H02K 37/16

(52) U.S. Cl. CPC H02K 1/143; H02K 37/16

(57) ABSTRACT

Disclosed is a doughnut type electromagnetic motor (100) having C-shaped stator windings (1), including C-shaped stator windings, a bearing shaft rod (2), permanent magnets (3), an adjustment circuit board (4), and a flat circular housing (5). The flat circular housing is configured to provide an ultrathin appearance structure for the motor. The permanent magnets serving as rotors are distributed along a second circle parallel to the flat circular housing, and are connected to the bearing shaft rod in the center of the motor by means of connectors, so as to form a permanent magnet rotor structure with the bearing shaft rod as a fulcrum. The C-shaped stator winding serving as a stator is arranged in a transverse direction of the permanent magnet rotor, and the permanent magnet rotor can pass through an inner ring of the C-shaped stator winding during rotating. The structure of the motor is simpler, the torque is increased, and the stator and the rotor can be separately processed and assembled, which makes the production more simplified and the practicability high.

### TECHNICAL FIELD

The present disclosure belongs to the technical field of motors, relates to an electromagnetic motor, and in particular to a doughnut type electromagnetic motor having C-shaped stator windings.

### BACKGROUND

At present, the existing permanent magnet brushless motor has a large number of wire sets and magnetic blocks (generally, one motor is provided with a dozen or twenty groups of wire sets and magnetic blocks), which leads to not only complicated production and mounting process, but also high manufacturing cost and high failure rate. Based on this, it is particularly important to propose a small brushless motor with further simplified structure, further reduced cost and high torque to meet the current market demand.

### SUMMARY

An objective of the present disclosure is to provide a doughnut type electromagnetic motor having C-shaped stator windings. Permanent magnets are transversely arranged on two poles of the motor as rotors, which makes the structure simpler and torque increased, thus solving the problems of complicated production and mounting process and high manufacturing cost in the prior art.

To achieve the objective above, the present disclosure provides the following solutions:

The present disclosure provides a doughnut type electromagnetic motor having C-shaped stator windings, including:

multiple C-shaped stator windings, each including C-shaped soft iron and an insulated wire wound around the periphery of the C-shaped soft iron, where the multiple C-shaped stator windings are distributed along the periphery of a first circle at intervals, and the cross section of any C-shaped soft iron cut along a radial direction of the first circle is C-shaped;

a bearing shaft rod, arranged at the center of the first circle and parallel to a central symmetry axis of the first circle;
multiple permanent magnets, where the number of the permanent magnets are the same as that of the C-shaped stator windings, the multiple permanent magnets are distributed along the periphery of a second circle at intervals, and any permanent magnet is connected to the bearing shaft rod by means of a connector to form a permanent magnet rotor; the second circle and the first circle are provided concentrically, the second circle is located at an inner ring of the first circle, and the permanent magnet rotors rotate to drive the permanent magnets to pass through magnetic fields at inner rings of the C-shaped stator windings;

an adjusting circuit board, arranged on the bearing shaft rod in a penetrating manner; and

a flat circular housing, configured to encapsulate the C-shaped stator windings, the permanent magnets, the adjusting circuit board and the connectors therein, wherein the flat circular housing is parallel to the first circle, and an entire circle of edge of the flat circular housing protrudes outwards along the outer contours of the C-shaped stator windings.

Alternatively, the cross section of any C-shaped soft iron cut along the radial direction of the first circle is in the shape of “U”. Compared with the “C” shape, the “U” shape has more extreme requirements for the thickness of soft iron.

Alternatively, any permanent magnet is an arc-shaped cylindrical permanent magnet extending in a circumferential direction of the second circle.

Alternatively, the axis of any permanent magnet is located on a circumferential line of the second circle, and a diameter of the circumferential line of the second circle is ⅘ of an inner diameter of the flat circular housing.

Alternatively, an even number of permanent magnets and an even number of C-shaped stator windings are provided.

Alternatively, four permanent magnets and four C-shaped stator windings are provided. The four permanent magnets and the four C-shaped stator windings are symmetrically distributed along the second circle and the first circle, respectively.

Alternatively, the connector is a flat cross bracket. The flat cross bracket is fixed to the bearing shaft rod and includes four outer mounting ends, and any outer mounting end of the flat cross bracket is provided with one permanent magnet.

Alternatively, every two opposite C-shaped stator windings in the four C-shaped stator windings are a pair; and the two pairs of C-shaped stator windings are crossed and connected in parallel.

Two magnetic poles close to each other of any two adjacent permanent magnets are of the same polarity.

Alternatively, every two opposite C-shaped stator windings in the four C-shaped stator windings are a pair; and the two pairs of C-shaped stator windings are crossed and arranged at an acute angle.

The four permanent magnets are uniformly distributed along the second circle at intervals, and two magnetic poles close to each other of any two adjacent permanent magnets are of different polarities.

Alternatively, the flat cross bracket is attached to the adjusting circuit board.

Alternatively, the adjusting circuit board is provided with cooling holes.

Alternatively, the flat cross bracket is a centrally symmetric metal bracket.

Alternatively, when an odd number of permanent magnets and an odd number of C-shaped stator windings are provided, the electromagnetic motor is further provided with an asynchronous commutation electronic speed controller.

Alternatively, the C-shaped soft iron is formed by extruding a rectangular soft iron sheet.

Alternatively, the electromagnetic motor is further provided with a position transducer, and the position transducer is arranged in the flat circular housing.

Alternatively, two position transducers are arranged at intervals.

In accordance with the doughnut type electromagnetic motor having C-shaped stator windings disclosed by the present disclosure, the flat circular housing is configured to provide an ultrathin appearance structure for the motor. The permanent magnets serving as rotors are distributed along the second circle parallel to the flat circular housing to achieve the transverse arrangement of the permanent magnet rotors, and are connected to the bearing shaft rod in the center of the motor by means of the connector to form a lever structure with the bearing shaft rod as a fulcrum, and thus the torque of the rotors can be increased. In addition, the C-shaped stator winding serving as a stator is arranged in a transverse direction of the permanent magnet rotor, and the permanent magnet rotor can pass through inner ring of the C-shaped stator winding during rotating. The C-shaped stator winding can generate a relatively maximum wrapping magnetic field (the maximum here refers to the maximum magnetic field that can be generated on the C-type stator winding when the permanent magnet passes through, that is, the permanent magnet has the largest work area at this time, rather than comparing with other magnetic fields) and magnetic field force, thus improving the operating efficiency of the motor. As can be seen from the above, the electromagnetic motor of the present disclosure has a simpler structure, direct work and increased torque, and the stator and the rotor can be processed and assembled separately, which is more simplified than the existing production mode of connecting more than a dozen or twenty wire sets together, and solves the problems of complicated production and mounting process, high manufacturing cost and the like in the prior art. The unique ultrathin shape of doughnut can adapt to more applications and special needs, such as electric tools, electric bicycles and the like, and has high practicability.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an internal structure of a doughnut type electromagnetic motor having C-shaped stator windings in accordance with an embodiment I of the present disclosure;

FIG. 2 is a schematic diagram of a longitudinal profile of a doughnut type electromagnetic motor having C-shaped stator windings in accordance with an embodiment I of the present disclosure;

FIG. 3 is a distribution schematic diagram of a magnetic field generated by a C-shaped stator winding in accordance with an embodiment of the present disclosure;

FIG. 4 is a winding arrangement diagram of an insulated wire in a C-type stator winding disclosed in accordance with an embodiment of the present disclosure;

FIG. 5 is a schematic diagram of an internal structure of a doughnut type electromagnetic motor having C-shaped stator windings in accordance with an embodiment II of the present disclosure.

In the drawings:
1—C-shaped stator winding; 11—C-shaped soft iron; 12—insulated wire; 13—soft iron core; 14—C-shaped stator winding I; 15—C-shaped stator winding II; 16—C-shaped stator winding III; 17—C-shaped stator winding IV;
2—bearing shaft rod;
3—permanent magnet;
4—adjusting circuit board;
5—flat circular housing;
6—flat cross bracket;
7—cooling hole;
8—position transducer;
9—winding coil connecting wire.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

One of the objectives of the present disclosure is to provide a doughnut type electromagnetic motor having C-shaped stator windings. Permanent magnets are transversely arranged on two poles of the motor as rotors, which makes the structure simpler and torque increased, thus solving the problems of complicated production and mounting process and high manufacturing cost in the prior art.

To make the objectives, features and advantages of the present disclosure more apparently and understandably, the following further describes the present disclosure in detail with reference to the accompanying drawings and the specific embodiments.

### Embodiment I

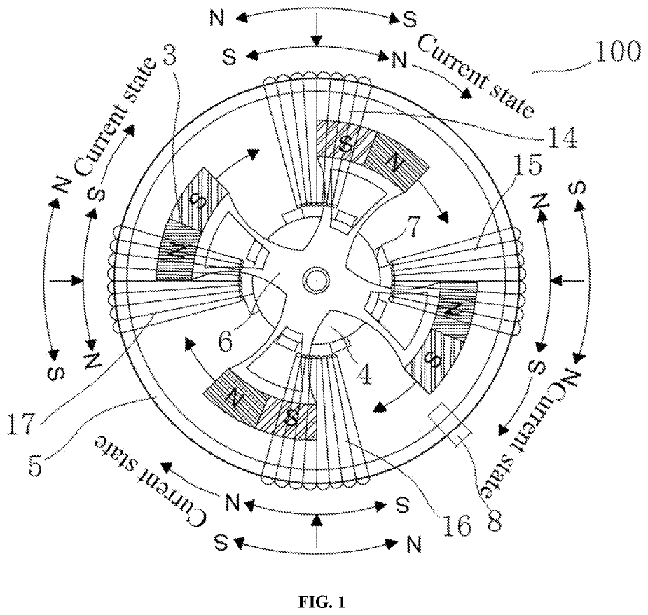

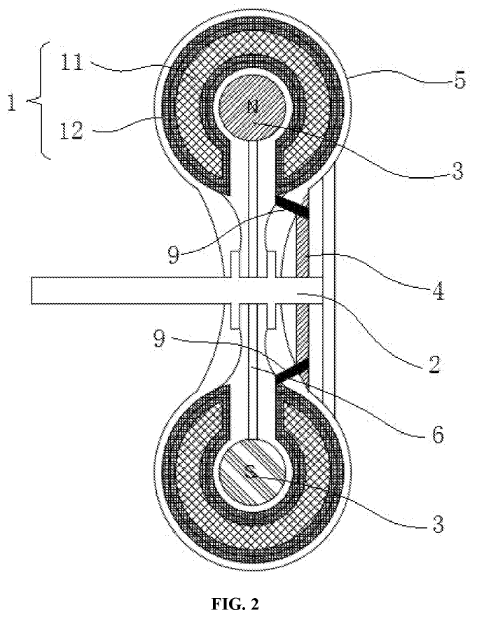

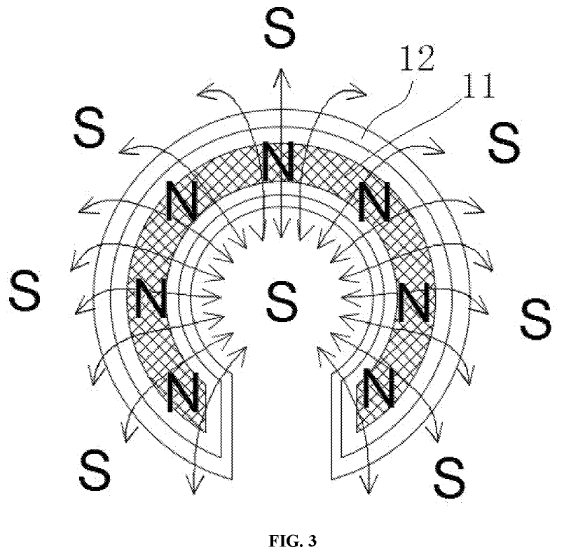

As shown in FIG. 1 to FIG. 4, this embodiment provides a doughnut type electromagnetic motor 100 having a C-shaped stator windings. The electromagnetic motor 100 mainly includes C-shaped stator windings, a bearing shaft rod 2, permanent magnets 3, an adjusting circuit board 4, and a flat circular housing 5. Each C-shaped stator winding includes C-shaped soft iron 11 and an insulated wire 12 wound around the periphery of the C-shaped soft iron 11. Multiple C-shaped stator windings 1 are provided, and the multiple C-shaped stator windings 1 are distributed along the periphery of a first circle at intervals. The cross section of any C-shaped soft iron cut along a radial direction of the first circle is C-shaped, this is the reason why the entire C-shaped stator winding 1 is C-shaped. The bearing shaft rod 2 is arranged at the center of the first circle and parallel to a central symmetry axis of the first circle, i.e., the bearing shaft rod 2 is perpendicular to a plane where the first circle is located. Multiple permanent magnets 3 are provided, and the number of the permanent magnets 3 are the same as that of the C-shaped stator windings 1. The multiple permanent magnets 3 are distributed along the periphery of a second circle at intervals, and any permanent magnet 3 is connected to the bearing shaft rod 2 by means of a connector to form a permanent magnet rotor. The second circle and the first circle are provided concentrically, the second circle is located at an inner ring of the first circle, and thus the rotation of each permanent magnet rotor can drive the permanent magnet 3 to pass through a magnetic field at an inner ring of the C-shaped stator winding 1. The adjusting circuit board 4 is a conventional element in the existing brushless motor, specific structure and operating principle of which will not be descried in detail here. In this embodiment, the adjusting circuit board 4 is arranged on the bearing shaft rod 2 in a penetrating manner. The C-shaped stator winding 1, the permanent magnet 3, the adjusting circuit board and the connector are encapsulated into the flat circular housing 5. The flat circular housing 5 is parallel to the first circle, and an edge of the flat circular housing 5 completely protrudes outwards along the outer contour of the C-shaped stator winding 1. The called “doughnut” refers to a “doughnut” shape with a concave center and an entire circle of convex outer edge after the flat circular housing 5 is assembled, which looks like a doughnut (an existing dessert).

In this embodiment, the insulated wire 12 is an existing enameled wire.

In this embodiment, the adjusting circuit board 4 may also be provided at other space allowable positions except for the bearing shaft rod 2.

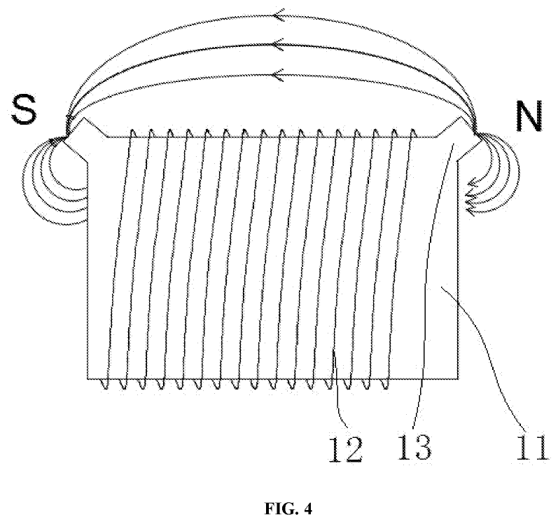

In this embodiment, any C-shaped soft iron 11 is provided with a soft iron core 13. In order to improve the fault tolerance, the soft iron core 13 is preferably arranged at an outward inclination of 5°-15° away from the C-shaped soft iron 11. As shown in FIG. 4, a lower eave of the soft iron core 13 protrudes to show an upward radian structure, which may also be in a hook shape of 180°.

In this embodiment, any permanent magnet 3 is an arc-shaped cylindrical permanent magnet extending in a circumferential direction of the second circle, and the permanent magnet may be made of a cylindrical permanent magnet in an arc shape by high-temperature die casting. Preferably, the axis of any arc-shaped cylindrical permanent magnet is located on a circumference line of the second circle.

In this embodiment, the cross section of any C-shaped soft iron 11 cut along the radial direction of the first circle is in the shape of “U”. Compared with the “C” shape, both sides of the “U” shape are flat, and when the thickness of the soft iron is required to be thinner, the C-type soft iron with a “U”-shape cross section cut along the radial direction of the first circle can be adopted. When the cross section of the C-shaped soft iron 11 cut along the radial direction of the first circle is in the shape of “C”, the permanent magnet 3 is generally arranged as the above arc-shaped cylindrical permanent magnet. When the cross section of the C-shaped soft iron 11 cut along the radial direction of the first circle is in the shape of “U”, the permanent magnet 3 is also correspondingly arranged as a flat permanent magnet. The shape of the permanent magnet may be determined according to the specific shape of the stator.

In practice, in order to pursue the ultrathin design of the motor, the C-shaped soft iron 11 can be divided into one or two parallel arc-shaped flat ultrathin stator structures, with the position and radian unchanged, and the permanent magnet 3 works on one side or both sides. Such a design can make the motor reach the thickness and size like two coins. If the middle bracket is designed as a dual-purpose type bracket that can be used as both a fan blade and a bracket, an unmanned aerial vehicle can be made into the size like a business card that can be put into a pocket.

In this embodiment, any C-shaped stator winding 1 is cylindrical when viewed transversely (a direction perpendicular to the plane where the first circle is located) and C-shaped when viewed longitudinally (the circumferential directions of the first circle and the second circle), this is mainly because the cross section of the C-shaped soft iron 11 cut along the radial direction of the first circle is C-shaped. The C-shaped soft iron 11 can be processed from a rectangular soft iron sheet formed by one-time extrusion, and the insulated wire 12 forms a semi-closed magnetic field by winding around the C-shaped soft iron 11. The inner ring of the C-shaped soft iron 11 is a magnetic field channel, and the cylindrical permanent magnet 3 with radian passes through the semi-closed magnetic field under the electromagnetic action. The advantage of the structural arrangement of the C-shaped stator is that an opening of the C-shaped stator winding 1 faces the center of the circle, and a current-excited magnetic pole works transversely in the circumferential direction, and the electromagnetic stator may generate the maximum wrapping magnetic field for the passing permanent magnet 3, which has the largest wrapping property and the largest working area.

In this embodiment, the number of the permanent magnets 3 may be two, three or four, which is in line with the dynamic balance. It is recommended that the number of the permanent magnets 3 does not exceed four in the motor with a small diameter. The number of the C-type stator windings 1 depends on the specific number of the rotors driven by the C-shaped stator windings.

In this embodiment, an even number of permanent magnets 3 and an even number of C-shaped stator windings 1 are provided. Preferably, four permanent magnets 3 and four C-shaped stator windings 1 are provided, and the four permanent magnets 3 and the four C-shaped stator windings 1 are symmetrically distributed along the second circle and the first circle, respectively, which makes the production and mounting process simplified. In practice, the number of the rotors (permanent magnet 3) and the stators (C-type stator winding 1) may be increased or reduced on the basis of “four” to achieve the same rotating effect, such as two rotors and three stators, three rotors and two stators, or three rotors and four stators.

In this embodiment, the connector is a flat cross bracket 6. The flat cross bracket 6 is fixed to the bearing shaft rod 2 and includes four outer mounting ends. One permanent magnet 3 is just mounted on each outer mounting end. When the number of the permanent magnets 3 is increased or reduced, especially when the number of the permanent magnets 3 is more than four, the flat cross bracket can be changed into a polygonal bracket structure with more than four outer mounting ends as required.

In this embodiment, every two opposite C-shaped stator windings 1 in the four C-shaped stator windings 1 is a pair. As shown in FIG. 1, the four C-shaped stator windings 1 is a C-shaped stator winding I 14, a C-shaped stator winding II 15, a C-shaped stator winding III 16, and a C-shaped stator winding IV 17. The C-shaped stator winding I 14, the C-shaped stator winding II 15, the C-shaped stator winding III 16 and the C-shaped stator winding IV 17 are sequentially arranged counterclockwise from a viewing angle shown in FIG. 1. The C-shaped stator winding I 14 and the C-shaped stator winding III 16 are a pair, the C-shaped stator winding II 15 and the C-shaped stator winding IV 17 are a pair. The two pairs of C-shaped stator windings 1 are of a dynamic balance symmetric structure, i.e., a quasi-cross shape. The wires of the two pairs of C-type stator windings 1 can be mutually connected in parallel. In practice, the four C-type stator windings 1 are distributed according to the requirements of a drive program.

In this embodiment, two magnetic poles close to each other of any two adjacent permanent magnets 3 in the four permanent magnets 3 are of the same polarity. That is, the S poles of any two adjacent permanent magnets 3 are close to each other, or the N poles of any two adjacent permanent magnets 3 are close to each other. Based on such a structural arrangement, there are permanent magnets 3 serving as the rotors passing through the inner rings of the two C-type stator windings 1 in each pair of C-type stator windings at the same time, but the magnetic poles of the permanent magnets 3 passing through the adjacent C-type stator windings 1 are just opposite, thus forming a staggered through-center structure arrangement of the stators (C-type stator windings 1) and the rotors (permanent magnets 3).

In this embodiment, the flat cross bracket 6 is attached to the adjusting circuit board 4. The four permanent magnets 3 and the four C-shaped stator windings 1, or the other number of permanent magnets 3 and the C-shaped stator windings 1 are uniformly distributed in a plane region where the flat cross bracket 6 is located. The adjusting circuit board 4 is arranged on one side of the flat cross bracket 6, thus making the overall structure of the motor have higher integration in the thickness direction to achieve the arrangement of the ultrathin motor structure.

In this embodiment, the adjusting circuit board 4 is provided with cooling holes 7, thus facilitating the adjusting circuit board 4 to operate for a long time and improve the operating efficiency.

In this embodiment, the flat cross bracket 6 is preferably a centrally symmetric metal bracket. The flat cross bracket 6 is provided with four supporting legs which are uniformly distributed at intervals. Each supporting leg may be of a platy structure or a rod-shaped structure, and an outer end of the supporting leg is the outer mounting end above and is used for mounting the permanent magnet 3. The permanent magnet 3 serving as the rotor is connected to the motor center (the bearing shaft rod) by means of the supporting leg of the flat cross bracket 6, thereby forming a lever structure with the motor center as a fulcrum between any permanent magnet 3 and the motor center, and the torque of the motor is increased.

Preferably, a diameter of the second circle (or a diameter of a circumferential line of the second circle) is ⅘ of an inner diameter of the flat circular housing 5, i.e., the permanent magnet 3 serving as the rotor makes a circular motion with a diameter close to ⅘ of the diameter of the whole motor. The above supporting leg is used as the radius of the circular motion, thus enabling the permanent magnet 3 to form an obvious lever structure with the shaft center (bearing shaft rod), which is conducive to further increasing the torque.

In this embodiment, when an odd number of permanent magnets 3 and an odd number of C-shaped stator windings 1 are provided, the motor is internally provided with an asynchronous commutation electronic speed controller.

In this embodiment, the C-shaped soft iron 11 is formed by extruding a rectangular soft iron sheet, and is preferably formed by one-time extrusion.

In this embodiment, the motor is further provided with a position transducer 8. The position transducer 8 is arranged in the flat circular housing 5, and is used to monitor the position of each permanent magnet 3 with respect to the C-shaped stator winding 1. By taking the rotation process of one of the permanent magnets 3 as an example, when the permanent magnet 3 has just rotated into a certain C-shaped stator winding 1 along its rotating direction, a forward current is introduced into the C-shaped stator winding 1 to make the C-shaped stator winding 1 generate an attractive force to the permanent magnet 3. When the position transducer 8 detects that the permanent magnet 3 is about to leave the C-shaped stator winding 1, the C-shaped stator winding 1 is powered off for a short time, and then a reverse current is introduced into the C-shaped stator winding 1 to make the C-shaped stator winding 1 exert a repulsive force on the permanent magnet 3, and so on. When any permanent magnet 3 is rotated to any C-shaped stator winding 1, the C-shaped stator winding 1 may generate the attractive force to suck the permanent magnet 3 in and then generate the repulsive force to push the permanent magnet 3 out, which not only provides electromagnetic power for the rotation of the permanent magnet 3, but also ensures the normal operation of the motor. During the actual mounting, the position transducer 8 may be arranged on an inner wall of the flat circular housing 5 or on the adjusting circuit board 4. Preferably, the position transducer 8 is provided between any two adjacent C-shaped stator windings 1 to ensure the precise control and operation of the motor.

In a case that there is no requirement for the motor brushless, the C-type stator winding and the rotor have interchangeable properties, i.e., the C-type stator winding may also employ the permanent magnet, while the rotor can be a current exciter, or both stator and rotor are current exciters in the places with high temperature vibration requirements. The specific conditions can be adjusted according to the actual needs.

As can be seen above, according to the doughnut type electromagnetic motor having C-shaped stator windings disclosed in this embodiment, the flat circular housing is configured to provide an ultrathin appearance structure for the motor. The permanent magnets serving as rotors are distributed along the second circle parallel to the flat circular housing to achieve the transverse arrangement of the permanent magnet rotors, and are connected to the bearing shaft rod in the center of the motor by means of the connector to form a lever structure with the bearing shaft rod as a fulcrum, and thus the torque of the rotors can be increased. In addition, the C-shaped stator winding serving as a stator is arranged in a transverse direction of the permanent magnet rotor, and the permanent magnet rotor can pass through inner ring of the C-shaped stator winding during rotating. The C-shaped stator winding can generate a relatively maximum wrapping magnetic field (the maximum here refers to the maximum magnetic field that can be generated on the C-type stator winding when the permanent magnet passes through, that is, the permanent magnet has the largest work area at this time, rather than comparing with other magnetic fields) and magnetic field force, thus improving the operating efficiency of the motor. As can be seen from the above, the electromagnetic motor of the present disclosure has a simpler structure, direct work and increased torque, and the stator and the rotor can be processed and assembled separately, which is more simplified than the existing production mode of connecting more than a dozen or twenty wire sets together, and solves the problems of complicated production and mounting process, high manufacturing cost and the like in the prior art. The unique ultrathin shape of doughnut can adapt to more applications and special needs, such as electric tools, electric bicycles and the like, and has high practicability.

In this embodiment, the C-shaped stator winding and the rotor work horizontally, which is in line with the optimal mechanics principle. Compared with the traditional oblique longitudinal work, the pressure on the bearing is reduced, and the vibration and the noise of the motor are correspondingly reduced.

In addition, the doughnut type electromagnetic motor having C-shaped stator windings disclosed in this embodiment has a flat and circular doughnut type structure, which makes the motor have a longer diameter (greater torque) and a smaller thickness than other motors, and the leverage effect is further strengthened.

### Embodiment II

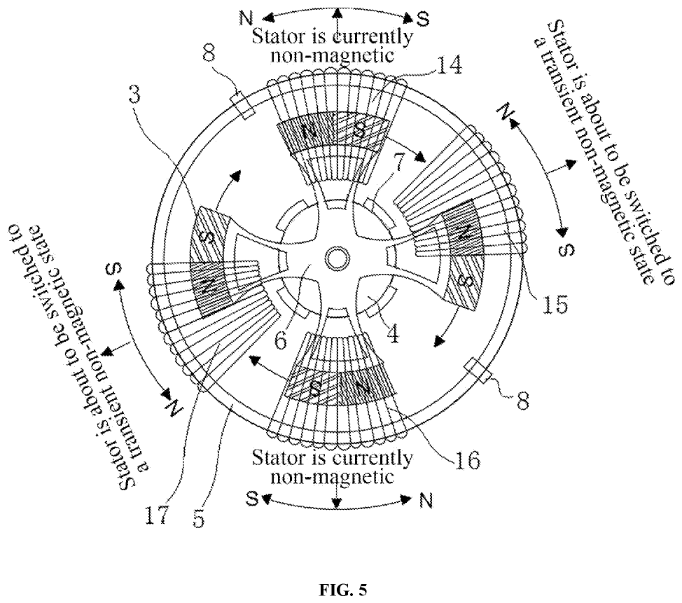

This embodiment provides another doughnut type electromagnetic motor having C-shaped stator windings. According to different uses of the motor, different numbers of C-type stator windings 1 and rotor permanent magnets can be employed. The only difference between this embodiment and Embodiment I is that a distribution form of the C-type stator windings 1 and a magnetic pole distribution form of the permanent magnets 3 are different, specifically as shown in FIG. 5. Four C-shaped stator winding 1 and four permanent magnets 3 are provided as above. The C-shaped soft iron 11 in each C-shaped stator winding 1 and the permanent magnet 3 serving as a rotor are both of an arc-shaped structure. The four permanent magnets 3 are located on the same circumference, and the four C-shaped soft irons 11 are located on the same circumference. Preferably, central angles of any C-shaped soft iron 11 and any permanent magnet 3 are both 40°. The four permanent magnets 3 are uniformly and symmetrically distributed on the circumference, while the four C-shaped stator windings 1 are not uniformly distributed, but are divided into two groups in pairs, with two C-shaped stator windings in one group opposite to each other. As shown in FIG. 5, the C-shaped stator winding I 14 and the C-shaped stator winding III 16 are a group, the C-shaped stator winding II 15 and the C-shaped stator winding IV 17 are a group. The C-shaped stator winding I 14 and the C-shaped stator winding III 16 are symmetrically arranged at an angle of 180°, and the C-shaped stator winding II 15 and the C-shaped stator winding IV 17 are also symmetrically arranged at an angle of 180°. The two groups of C-type stator windings 1 are arranged at an acute angle, i.e., any two adjacent C-type stator windings 1 are arranged at a deflection angle. Specifically, as shown in FIG. 5, during the normal rotation of the rotors, when the C-type stator winding I 14 and the C-type stator winding III 16 are in a non-magnetic state, the C-type stator winding II 15 and the C-type stator winding IV 17 are in the transition from N-pole to S-pole.

In accordance with the doughnut type electromagnetic motor having C-shaped stator windings disclosed in this embodiment, the permanent magnet rotor can pass through the inner ring of the C-shaped stator winding during the rotation, and the C-shaped stator winding can generate a relatively maximum wrapping magnetic field (the maximum here refers to the maximum magnetic field that can be generated on the C-type stator winding when the permanent magnet passes through, that is, the permanent magnet has the largest working area at this time, rather than comparing with other magnetic fields) and magnetic field force, thus improving the operating efficiency of the motor. As can be seen from the above, the electromagnetic motor of the present disclosure has a simpler structure and increased torque, and the stator and rotor can be processed and assembled separately, which is more simplified than the existing production mode of connecting more than a dozen or twenty wire sets together, and solves the problems of complicated production and mounting process, high manufacturing cost and the like in the prior art. The unique ultrathin shape of doughnut can adapt to more applications and special needs, such as electric tools, electric bicycles and the like, and has high practicability.

In this embodiment, the C-shaped stator winding and the rotor work horizontally, which is in line with the optimal mechanics principle. Compared with the traditional oblique longitudinal work, the pressure on the bearing is reduced, and the vibration and the noise of the motor are correspondingly reduced.

It should be noted that: for those skilled in the art, apparently, the present disclosure is not limited to details of above exemplary embodiments, and may be expressed in other specific forms without departing from the spirit or basic characteristics of the present disclosure. Therefore, in any way, the embodiments should be regarded as exemplary, not limitative; and the scope of the present disclosure is limited by the appended claims, instead of the above description. Thus, all variations intended to fall into the meaning and scope of equivalent elements of the claims should be covered within the present disclosure. Any reference signs in the claims shall not be regarded as limitations to the concerned claims.

Several examples are used for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

1. A doughnut type electromagnetic motor having C-shaped stator windings, comprising:
a plurality of C-shaped stator windings, each comprising C-shaped soft iron and an insulated wire wound around the periphery of the C-shaped soft iron, wherein the plurality of C-shaped stator windings are distributed along the periphery of a first circle at intervals, and the cross section of any C-shaped soft iron cut along a radial direction of the first circle is C-shaped;
a bearing shaft rod, arranged at the center of the first circle and parallel to a central symmetry axis of the first circle;
a plurality of permanent magnets, wherein the number of the permanent magnets are the same as that of the C-shaped stator windings, the plurality of permanent magnets are distributed along the periphery of a second circle at intervals, and any permanent magnet is connected to the bearing shaft rod by means of a connector to form a permanent magnet rotor; the second circle and the first circle are provided concentrically, the second circle is located at an inner ring of the first circle, and the permanent magnet rotors rotate to drive the permanent magnets to pass through magnetic fields at inner rings of the C-shaped stator windings;
an adjusting circuit board, arranged on the bearing shaft rod in a penetrating manner; and
a flat circular housing, configured to encapsulate the C-shaped stator windings, the permanent magnets, the adjusting circuit board and the connectors therein, wherein the flat circular housing is parallel to the first circle, and an entire circle of edge of the flat circular housing protrudes outwards along the outer contours of the C-shaped stator windings.

2. The doughnut type electromagnetic motor having C-shaped stator windings according to claim 1, wherein any permanent magnet is an arc-shaped cylindrical permanent magnet extending along a circumferential direction of the second circle.

3. The doughnut type electromagnetic motor having C-shaped stator windings according to claim 2, wherein the axis of any arc-shaped cylindrical permanent magnet is located on a circumferential line of the second circle, and a diameter of the circumferential line of the second circle is ⅘ of an inner diameter of the flat circular housing.

4. The doughnut type electromagnetic motor having C-shaped stator windings according to claim 1, wherein an even number of permanent magnets and an even number of the C-shaped stator windings are provided.

5. The doughnut type electromagnetic motor having C-shaped stator windings according to claim 4, wherein four permanent magnets and four C-shaped stator windings are provided; the four permanent magnets and the four C-shaped stator windings are symmetrically distributed along the second circle and the first circle, respectively.

6. The doughnut type electromagnetic motor having C-shaped stator windings according to claim 5, wherein the connector is a flat cross bracket, the flat cross bracket is fixed to the bearing shaft rod, and comprises four outer mounting ends; and any mounting outer end is provided with one permanent magnet.

7. The doughnut type electromagnetic motor having C-shaped stator windings according to claim 5, wherein every two opposite C-shaped stator windings in the four C-shaped stator windings are a pair; and the two pairs of C-shaped stator windings are crossed and connected in parallel;
two magnetic poles close to each other of any two adjacent permanent magnets are of the same polarity.

8. The doughnut type electromagnetic motor having C-shaped stator windings according to claim 5, wherein every two opposite C-shaped stator windings in the four C-shaped stator windings are a pair; and the two pairs of C-shaped stator windings are crossed and arranged at an acute angle;
the four permanent magnets are uniformly distributed along the second circle at intervals, and two magnetic poles close to each other of any two adjacent permanent magnets are of different polarities.

9. The doughnut type electromagnetic motor having C-shaped stator windings according to claim 1, wherein when an odd number of permanent magnets and an odd number of C-shaped stator windings are provided, the electromagnetic motor is further provided with an asynchronous commutation electronic speed controller.

10. The doughnut type electromagnetic motor having C-shaped stator windings according to claim 1, wherein the C-shaped soft iron is formed by extruding a rectangular soft iron sheet.

11. The doughnut type electromagnetic motor having C-shaped stator windings according to claim 1, wherein the electromagnetic motor is further provided with a position transducer, and the position transducer is arranged in the flat circular housing.

12. The doughnut type electromagnetic motor having C-shaped stator windings according to claim 2, wherein an even number of permanent magnets and an even number of the C-shaped stator windings are provided.

13. The doughnut type electromagnetic motor having C-shaped stator windings according to claim 3, wherein an even number of permanent magnets and an even number of the C-shaped stator windings are provided.

14. The doughnut type electromagnetic motor having C-shaped stator windings according to claim 12, wherein four permanent magnets and four C-shaped stator windings are provided; the four permanent magnets and the four C-shaped stator windings are symmetrically distributed along the second circle and the first circle, respectively.

15. The doughnut type electromagnetic motor having C-shaped stator windings according to claim 13, wherein four permanent magnets and four C-shaped stator windings are provided; the four permanent magnets and the four C-shaped stator windings are symmetrically distributed along the second circle and the first circle, respectively.

16. The doughnut type electromagnetic motor having C-shaped stator windings according to claim 14, wherein the connector is a flat cross bracket, the flat cross bracket is fixed to the bearing shaft rod, and comprises four outer mounting ends; and any mounting outer end is provided with one permanent magnet.

17. The doughnut type electromagnetic motor having C-shaped stator windings according to claim 15, wherein the connector is a flat cross bracket, the flat cross bracket is fixed to the bearing shaft rod, and comprises four outer mounting ends; and any mounting outer end is provided with one permanent magnet.

18. The doughnut type electromagnetic motor having C-shaped stator windings according to claim 14, wherein every two opposite C-shaped stator windings in the four C-shaped stator windings are a pair; and the two pairs of C-shaped stator windings are crossed and connected in parallel;
two magnetic poles close to each other of any two adjacent permanent magnets are of the same polarity.

19. The doughnut type electromagnetic motor having C-shaped stator windings according to claim 15, wherein every two opposite C-shaped stator windings in the four C-shaped stator windings are a pair; and the two pairs of C-shaped stator windings are crossed and connected in parallel;
two magnetic poles close to each other of any two adjacent permanent magnets are of the same polarity.

20. The doughnut type electromagnetic motor having C-shaped stator windings according to claim 14, wherein every two opposite C-shaped stator windings in the four C-shaped stator windings are a pair; and the two pairs of C-shaped stator windings are crossed and arranged at an acute angle;
the four permanent magnets are uniformly distributed along the second circle at intervals, and two magnetic poles close to each other of any two adjacent permanent magnets are of different polarities.
